(19) United States
(12) Patent Application Publication
(10) Pub. No.: US 2006/0146796 A1
(43) Pub. Date: Jul. 6, 2006

(54) Method and apparatus for multiple unicast delivery of media

(75) Inventors: Gigo K. Joseph, Arlington Heights, IL (US); Devarajan S. Puthupparambil, Mount Prospect, IL (US)

Correspondence Address: PATENTS AND LICENSING LLC;DANIEL W. JUFFERNBRUCH, 28 BARRINGTON BOURNE, BARRINGTON, IL, 60010-9605, US

(73) Assignee: UTStarcom, Inc., Alameda, CA (US)

(21) Appl. No.: 11/027,317

(22) Filed: Dec. 31, 2004

(51) Int. Cl. H04L 12/66

(52) U.S. Cl. 370/352

(57) ABSTRACT

Unicast delivery of media to multiple recipients is achieved. An originating client issues call setup request. A list of addresses of multiple recipient clients is obtained from the call setup request. A connection is then made with the plurality of recipient clients and the media is delivered from the originating client to the plurality of recipient clients. A universal user port agent receives the list of addresses from the originating client and makes the connection with the plurality of recipient clients. When an originating client receives a reply message that a recipient client is unavailable, it may be built with the capability to search for alternate addresses and send a new call setup request.

### BACKGROUND OF THE INVENTIONS

1. Technical Field

The present inventions relate to communications and, more particularly, relate to communication delivery to multiple destinations.

2. Description of the Related Art

The Internet Engineering Taskforce (IETF) has published a Request for Comments (RFC) setting forth the specifications for the Session Initiation Protocol known as SIP. This RFC is “SIP: Session Initiation Protocol,” RFC 3261, by J. Rosenberg et. al., June 2002.

The Session Initiation Protocol (SIP) is an application-layer control (signaling) protocol for creating, modifying, and terminating sessions with one or more participants. These sessions include Internet telephone calls, multimedia distribution, and multimedia conferences.

The Session Initiation Protocol (SIP) provides for creating, modifying, and terminating sessions with participants one at a time. If you need to send the same media to ‘N’ participants, you have to make individual calls and leave the same media message ‘N’ number of times.

No method is available to setup sessions with multiple participants other than to individually make multiple invitation requests. This burdens a sending client and the system.

### SUMMARY OF THE INVENTIONS

An object of the present inventions is to provide a way to setup point to multipoint calls and broadcast a unicast media message.

A further object of the present inventions is to perform the unicast delivery of media to multiple recipients.

Another object of the present inventions is to utilize a list of addresses of multiple recipient clients.

Another further object of the present inventions is for an originating client to play certain media continuously while a universal user port agent delivers the media to all the addresses given to it for dialing out.

An additional object of the present inventions is for an originating client to make one call to ‘N’ participants in order to leave the same media.

Unicast delivery of media to multiple recipients is achieved. An originating client issues call setup request. A list of addresses of multiple recipient clients is obtained from the call setup request. A connection is then made with the plurality of recipient clients and the media is delivered from the originating client to the plurality of recipient clients. A universal user port agent receives the list of addresses from the originating client and makes the connection with the plurality of recipient clients. The connection is made to the multiple receiving clients by sending a plurality of call setup requests from a universal user port agent. When an originating client receives a reply message that a recipient client is unavailable, it may be built with the capability to search for alternate addresses and send a new call setup request. In certain embodiments the media delivery is setup using a version of the Session Initiation Protocol (SIP).

The media is delivered from the originating client to a universal port user agent over an internet protocol and from the universal port user agent to at least one destination client over a public switched telephone network or an internet protocol. The media is delivered in real time using a real time protocol. The call setup requests comprise an invite command comprising some addresses having IP domains and others having PSTN domains.

When an originating client device receives a reply message that a particular recipient client is unavailable, the client device can search for alternate addresses and send a new call setup request with an alternate address.

The details of the preferred embodiments and these and other objects and features of the inventions will be more readily understood from the following detailed description when read in conjunction with the accompanying drawings wherein:

### BRIEF DESCRIPTION OF THE DRAWINGS

FIG. 1 illustrates a schematic block diagram of a communications system according to the present inventions; and

FIG. 2 illustrates a flow diagram of exemplary call flows in the communications system of the present inventions.

### DETAILED DESCRIPTION OF THE PREFERRED EMBODIMENTS

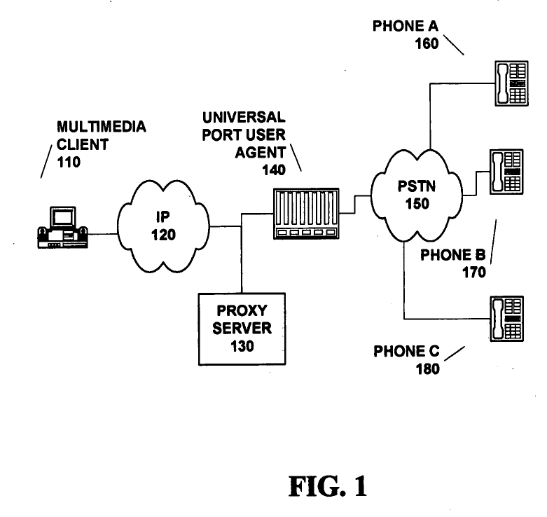

FIG. 1 illustrates a schematic block diagram of a communications system according to the present inventions. A multimedia client 110 can ask to a universal port user agent 140 through an Internet Protocol (IP) connection 120. The multimedia client 110 is a user application on an IP telephone or a general-purpose multimedia capable computer having a processor and a communications port. A proxy server 130 couples to the IP connection between the universal port user agent 140 and the multimedia client 110. The universal port user agent 140 is a multi port gateway or multi access gateway for creating, modifying, and terminating sessions with one or more participants in a multimedia environment. Via the universal port user agent 140 the multimedia client 110 can thereby transmit media such as Internet telephone calls, multimedia distributions, and multimedia conferences.

The media transmitted by the multimedia client 110 can be at the universal port user agent 140 destined for multiple recipient clients. In the preferred embodiment illustrated in FIG. 1, phone A 160, phone B 170, and phone C 180 make up the recipient clients and connect to the universal port user agent 140 through a public switched telephone network (PSTN) 150. The recipient clients can be IP telephones that connects through an Internet Protocol (IP) connection. Besides telephones, the recipient clients can also be other kinds of client devices such as PCs running media applications and IP phones.

The term ‘universal port’ in the phrase ‘universal port user agent’ means a universal port gateway. A universal port gateway is the same as a multi port gateway or multi access gateway. When the universal port gateway is used for creating, modifying, and terminating sessions with one or more participants in a multimedia environment, it is a universal port user agent. These sessions include internet telephone calls, multimedia distribution, and multimedia conferences.

The universal port user agent 140 is constructed in the preferred embodiment of processor cards and port cards on a chassis such as the Total Control 1000® by UTStarcom, Inc. The Total Control 1000® chassis consists of one network management card and up to 16 application cards, each application card providing, for example, digital signal processors for coupling to a public switched telephone network (PSTN) for analog modem dial-up access lines or Voice over IP (VoIP) connections. The universal port user agent resides in media gateway applications. The media gateway applications run on the ARC (access router card) of the Total Control 1000° chassis.

An originating multimedia client 110 sends a single invite request with more than one address for destination clients. The multiple addresses in this single invite request are multiple uniform resource indicators (URIs) to dial out from the universal port user agent. Within the chassis of the universal port user agent an ARC (access router card) dials out to all the PSTN numbers provided in the single invite request and transmit in unicast the media such as a message it receives over the IP 120 to the PSTN 150.

The system involves modifications to Session Initiation Protocol (SIP) message headers, new SIP headers and modifications to Gateway call handling.

The multimedia client 110 simultaneously broadcasts media to multiple recipient clients 160, 170 and 180 at the same time and subject to the availability of the recipient's phone lines.

In an example scenario, a messaging application program for a doctor, residing on an originating multimedia client 110, wants to leave a multimedia message with ‘N’ number of its patients. In this scenario the doctor wants to speak that he or she is running one hour late. In the existing SIP mode a user agent of the originating client has to make ‘N’ individual calls and leave same message to everyone.

Using the present inventions, in this scenario, the doctor's originating client needs to make a single request to call these multiple destination clients such as PSTN phones A, B and C 160, 170 and 180. To do so, the doctor's originating client 110 sends a single INVITE request with multiple request URI headers. Each request URI has a number for ARC (access router card) to dial out. The universal port user agent 140 or gateway will accept the call from the messaging application on the multimedia client 110 and the spoken multimedia message will start playing on the specific Real Time Protocol (RTP) port. The universal port user agent 140 preferably will simultaneously dial out the all the numbers indicated by the URIs in the INVITE request and connect to each of them separately and play out the media received from the application. All of the dials outs do not need to occur simultaneously. Even though simultaneous dial out is preferred; some of the ports on the universal port user agent 140 might be busy.

The INVITE request from the originating client 110 should have a suitable media timer parameter which will specify the time necessary to play out a recorded media message. The universal port user agent 140 will play out the message for a sufficient time so as to ensure a fair delivery of a media message. An approach for playing the media allows at least twice the media message length in order for a recipient to hear the media more than one. The recipient needs to the message more than once in this approach because the playing of the media might begin in the middle. The playing of the message would then repeat a second time to ensure the full message is received.

The universal port user agent 140 will dial the various numbers simultaneously and connect to each of them and play the message on each of the connections. The gateway will report the status of each call, back to the originating client using a NOTIFY message.

Once the media is played out for the required time as determined by the universal port user agent 140 based on the timer value in the INVITE message, the universal port user agent 140 will bring down that connection in a proper manner. This is repeated for each of the connections to the multiple destination clients 160, 170 and 180 that may have been made. When all the connections are torn down after successful transmission of the message the universal port user agent 140 will disconnect with the messaging application and messaging application of the originating client 110 will stop playing the message.

The Internet Engineering Taskforce (IETF) as published a Request for Comments (RFC) setting forth the specifications for the Session Initiation Protocol known as SIP. This RFC is “SIP: Session Initiation Protocol,” RFC 3261, by J. Rosenberg et. al., June 2002. The most pertinent portions of RFC 3261 are sections 1-9, 12-17 and 24.

The abstract of the IETF RFC 3261 by J. Rosenberg et. al. defines the Session Initiation Protocol (SIP) as follows:

This document describes Session Initiation Protocol (SIP), an application-layer control (signaling) protocol for creating, modifying, and terminating sessions with one or more participants. These sessions include Internet telephone calls, multimedia distribution, and multimedia conferences.

SIP invitations used to create sessions carry session descriptions that allow participants to agree on a set of compatible media types. SIP makes use of elements called proxy servers to help route requests to the user's current location, authenticate and authorize users for services, implement provider call-routing policies, and provide features to users. SIP also provides a registration function that allows users to upload their current locations for use by proxy servers. SIP runs on top of several different transport protocols.

An example of a standard SIP INVITE format is:
INVITE sip:bob@biloxi.com SIP/2.0
as disclosed by the F2 example in section 24.2 of RFC 3261.

A new invite command is proposed by the present inventions that contains multiple addresses for the multiple unicast delivery of media to destination clients. In the SIP INVITE format, for three destination clients, this command might look like:
INVITE sip:bob@biloxi.com, 8476361000@sbc34.com, tom@atlantaip.com SIP/2.0.

The comma and space characters separating the multiple addresses could alternatively be replaced with other separators such as semicolons or colons and/or the space characters omitted.

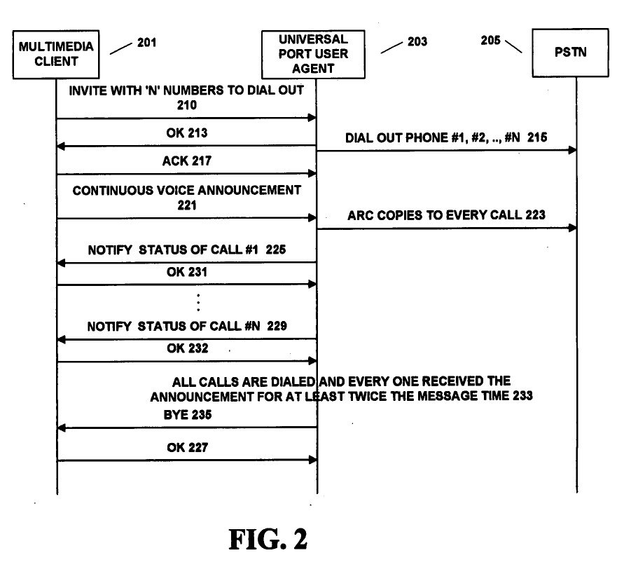

FIG. 2 illustrates a flow diagram of exemplary call flows in the communications system of the present inventions. A multimedia client 201 since an invite request with ‘N’ numbers to dial out 210. A universal port user agent 203 receives the invite request 210 and generates and OK message 213. The OK message is a preferably a SIP 200 OK message for successful connection.

The universal port user agent 203 then simultaneously dials out to recipient clients over the public switched telephone network (PSTN). At step 215 phone #1, phone #2 and so forth to phone #N is dialed. The universal port user agent 203 receives acknowledgment ACK message 217 from the multimedia client 201. Acknowledgment message 217 is an acknowledgment that the OK message 213 was received. The multimedia client 201 then delivers, to the universal port user agent 203, the media such as a voice announcement continuously at step 221. At 223, the universal port user agent 203, via its ARC (access router card) in a preferred embodiment, copies the media from the multimedia client 201 to every destination client and via the calls over the public switched telephone network (PSTN) 205. At the step 233, the calls from the user port user agent 203 to the recipient clients over the PSTN 205, once dialed and received, are held for a duration of at least about twice the media playback time to make sure the media is received.

As the ‘N’ calls are made by the universal port user agent 203, the universal port user agent 203 notifies the multimedia client 201 of the status of each of the ‘N’ calls by status messages 225 and 229. The multimedia client 201 provides OK messages 231 and 232 back to the universal port user agent 203.

Once the universal port user agent 203 has completed its task a bye message 235 is sent to the multimedia client 201 and the multimedia client replies with an OK 227.

The present inventions can be utilized for multiple PSTN broadcast applications using Voice over IP. This can be of extensive usage for broadcasting of stored messages, announcements, dialing out and leaving voice message. Without the present inventions, the individual call model still has to be used, which will take more time to finish the call and utilize more call resources. This solution will be one of unique significance offering SIP to multiple PSTN dial out which will be a value added service that carriers can offer to service industry customers. This also has significance to IP recipient client phones and other devices for receiving unicast media.

Although the inventions have been described and illustrated in the above description and drawings, it is understood that this description is by example only, and that numerous changes and modifications can be made by those skilled in the art without departing from the true spirit and scope of the inventions. Although the examples in the drawings depict only example constructions and embodiments, alternate embodiments are available given the teachings of the present patent disclosure. For example, although wireless examples are disclosed, the inventions are applicable to any media delivery system from IP to IP or Wireline PSTN and cellular communications.

What is claimed is:

1. A method of performing multiple unicast delivery of media from an originating client to a plurality of recipient clients, comprising the steps of:
(a) receiving a call setup request from the originating client;
(b) obtaining a list of addresses of the plurality of recipient clients from the call setup request; and
(c) connecting to the plurality of recipient clients.

2. A method according to claim 1, further comprising the step of:
(d) delivering media from the originating client to the plurality of recipient clients.

3. A method according to claim 2, wherein said step (d) of delivering the media from the originating client to the plurality of recipient clients comprises delivering the media for a duration of at least twice a playback length of the media.

4. A method according to claim 2, wherein said step (d) of delivering the media delivers the media from the originating client to a universal port user agent over an internet protocol and from the universal port user agent to at least one destination client over a public switched telephone network.

5. A method according to claim 2, wherein said step (d) of delivering the media delivers the media from the originating client to a universal port user agent over an internet protocol and from the universal port user agent to at least one destination client over a an internet protocol.

6. A method according to claim 1, wherein said step (c) of connecting to the plurality of recipient clients sends a plurality call setup requests.

7. A method according to claim 1, wherein said step (a) of receiving a call request receives an invite command comprising a plurality of addresses corresponding to the recipient clients.

8. A method according to claim 7, wherein said step (a) receives an invite command comprising addresses having PSTN domains.

9. A method according to claim 7, wherein said step (a) receives an invite command comprising some addresses having IP domains and others having PSTN domains.

10. A method according to claim 2, wherein said steps (a) of receiving and (d) of delivering are performed successively to transmit the media.

11. A method according to claim 1, further comprising the step of (e) reporting back to the originating client if one of the recipient clients is unavailable.

12. A method according to claim 1, further comprising the steps of:
(d) receiving a reply message that a particular recipient client is unavailable;
(e) searching for alternate addresses; and
(f) issuing a new call setup request with an alternate address.

13. A method according to claim 12,
wherein said method further comprises the step of (e) delivering to the reply message to the originating client;
wherein said step (e) of searching for alternate addresses searches at the originating client; and
wherein said step (f) of issuing a new request with the new address issues the request from the originating client.

14. A method according to claim 1, wherein the list of addresses obtained in said step (b) comprises telephone numbers.

15. A method according to claim 1, wherein the call setup request received in said step (a) is a modified SIP INVITE.

16. A method according to claim 1, wherein the multiple unicast delivery of media is in real time.

17. A method according to claim 1, wherein the steps are performed in a universal port user agent.

18. A universal user port agent for enabling multiple unicast deliveries of media from an originating client to a plurality of recipient clients, comprising a processor and communication ports to receive a call setup request from an originating client, to obtaining a list of addresses of the plurality of recipient clients from the call setup request, and to connect to a plurality of recipient clients.

19. A client device capable of multiple unicast deliveries of media to a plurality of recipient clients, comprising a processor and communication port to send a call setup request having a list of addresses of the plurality of recipient clients and to deliver media to the plurality of recipient clients.

20. A client device capable of multiple unicast deliveries of media according to claim 19, wherein, when the processor and communication port receive a reply message that a particular recipient client is unavailable, the processor searches for alternate addresses and sends a new call setup request with an alternate address.
